(19) United States
(12) Patent Application Publication
(10) Pub. No.: US 2011/0063289 A1
(43) Pub. Date: Mar. 17, 2011

(54) DEVICE FOR DISPLAYING STEREOSCOPIC IMAGES

(75) Inventor: Joachim Gantz, Dresden (DE)

(73) Assignee: SeeReal Technologies S.A., Munsbach (LU)

(21) Appl. No.: 12/991,469

(22) PCT Filed: May 8, 2009
(86) PCT No.: PCT/EP09/55575

§ 371 Date: Nov. 8, 2010

(30) Foreign Application Priority Data
May 8, 2008 (DE) 10 2008 001 644.6

(51) Int. Cl. G06T 15/00

(52) U.S. Cl. 345/419

(57) ABSTRACT

The invention relates to a device for displaying images, in particular three-dimensional images, in a reconstruction space using spatial points that are points of intersection of at least two intersecting light beam bundles. The device comprises an image display unit having image pixels for displaying image information and a beam alignment unit. The beam alignment unit emits the light beam bundle issuing from the image display unit in pre-defined directions so that at the points of intersection thereof at least one spatial point can be produced in the reconstruction space. The light beam bundles leaving the at least one spatial point are directed exclusively to at least one virtual viewing window provided in a viewing plane. The maximum extent of the virtual viewing window corresponds to the diameter of the pupils of the eyes of the observer and, said viewing window tracking the observer during lateral and/or axial movement.

The present invention relates to a device for the presentation of three-dimensional images in a reconstruction space by spatial points which are intersecting points of at least two intersecting pencils of rays. This invention further relates to a method for the presentation of three-dimensional images in a reconstruction space.

A number of ways of presenting images of objects are already known in the prior art.

The best known systems are currently stereoscopic or autostereoscopic display devices, where two images are projected which are separated by colour filters, polarisation filters or shutter spectacles, or which can be watched without such aids. In other words, these display devices have in common that the eyes of an observer are provided with different two-dimensional perspective views of the object to be presented. The major disadvantage of such display devices is that they cause an unnatural strain for the eyes which often leads to fatigue in the observer because of the conflict between the focussing and convergence angle of the observer eyes when watching the two two-dimensional images on a flat screen. However, this disadvantage can be minimised in that the observer eyes are provided with more than two perspective views. However, this increases the complexity and costs, and a satisfactory solution can only be achieved with so-called super-multi-view displays with a very large number of perspective views. A true spatial reconstruction of the object can still not be realised with that type of display device.

True spatial reconstructions can be realised with so-called volumetric display devices where the image points are generated in a light diffusing medium in a three-dimensional space. This way, the conflict between focussing and convergence cannot occur. However, that method only allows translucent objects to be presented, and those display devices cannot be used in daily life but only for advertising or other special purposes due to their great complexity.

A true reconstruction of a three-dimensional object in space can also be generated with the help of holography. Here, spatial points are reconstructed by way of diffraction of sufficiently coherent light at computed or otherwise generated grating structures, which are known as holograms. The spatial points are generated by interference in the reconstruction space of the wave fronts which are modulated by the hologram. The method is thus considered to be a wave-optical reconstruction method, where the reconstruction typically only takes place in a certain diffraction order. Such holographic methods make great demands both on the resolution of the display device and on the performance of the computers which are used for computing the holograms. Both the size of the reconstruction volume or reconstruction space and the visibility region depend on the diffraction angle which is determined by the pixel pitch of the display. Therefore, presently available means which are based on conventional holographic methods only allow small scenes or objects to be reconstructed in a visibility region which is still very small. Moreover, since sufficiently coherent light is required for the reconstruction, the three-dimensional presentation is always superposed by coherent noise, the so-called speckling, so that measures must be taken to suppress this speckling, and these measures may reduce the resolution of the display further again.

Another possibility of reconstructing real image points in a three-dimensional space is offered by a display device which is known as multi-beam display. In that type of display device, the image points are generated by pencils of rays which intersect in the reconstruction space. This requires at least two pencils of rays which are emitted by an image point or spatial point under an angle to fall on the eye pupil of an observer eye so to induce the eye to focus on the image point (monocular accommodation). To achieve a binocular three-dimensional perception of the image point, at least four pencils of rays which are emitted by the same image point are required, so that two pencils of rays fall on the eye pupil of the right observer eye, and two pencils of rays fall on the eye pupil of the left observer eye.

U.S. Pat. No. 6,798,390 B1 describes a display device which works on the basis of that principle. That display device comprises an image-carrying LC display and a further, second LC display, which is arranged in parallel with a certain gap in between. In conjunction with a field lens, the second LC display serves as directing display which is operated as a shutter panel. For example, to generate three image points or spatial points with the help of intersecting pencils of rays, three pixels are turned on one after another at different positions of the image-carrying LC display. A small opening or aperture which moves sequentially across the second LC display, which serves as a shutter panel, selects three pencils of rays which irradiate in different directions into the reconstruction space, which is situated behind the second LC display, seen in the direction of light propagation. If the pixels which are activated in the image-carrying LC display and the corresponding openings which are activated in the shutter panel are chosen accordingly, the pencils of rays which are thus generated one after another intersect such that three spatial points are generated. An observer can perceive these three spatial points from different viewing angles with different depth as a three-dimensional image.

However, such a display device has the disadvantage that the pencils of rays which generate the spatial points are generated sequentially through a single aperture. This is why the reconstructed three-dimensional image has a rather low brightness; while in addition great demands are made on the switching speed of the second LC display, which is operated to serve as a shutter panel. U.S. Pat. No. 6,798,390 B1 further describes that the image-carrying LC display can be replaced by an LED arrangement. This way the lighting conditions are improved, but the general disadvantage of the sequential generation of the pencils of rays in a large visibility region persists.

U.S. Pat. No. 6,798,390 B1 describes in the context of a further embodiment of the display device the limitation of the visibility region of the three-dimensional presentation to a defined small region in which the head of the observer is situated at a given moment. The position of the head of the observer is determined by a position detection system. The different visibility regions (solid angle which includes at least the head of the observer, but which is typically larger) which correspond with the head positions of the observer are represented by different regions of the image-carrying LC display. This reduces the demands made on the switching speed of the second LC display, but the resolution of the three-dimensional presentation is reduced to the same degree.

The above-mentioned disadvantages can be circumvented by increasing the number of image-carrying and directing systems in a display device. Such a display device is known for example from document US 2003/0156077 A1. The pencils of rays which intersect in the reconstruction space are there generated by multiple micro-displays which are disposed side by side and one above another in the horizontal and vertical direction in combination with special optical imaging systems. The arrangement of micro-displays is preceded by a passive screen with a diffusion characteristic which broadens the pencils of rays which are emitted by the micro-displays such that they are adjoined angle-wise without gaps and that thereby spatial points are generated which lie closely side by side. The thus generated spatial points are visible in the region in front of, on or behind the screen. This way a multitude of perspective views of a three-dimensional image can be generated in a certain solid angle, where said perspective views can be perceived by an observer one after another with both eyes when he moves or by multiple observers simultaneously. This also ensures the ability of the display device to support multiple users. The three-dimensional impression of the presented image is additionally strengthened by the motion parallax. The visibility region and the number of perspectives depend on the geometry of the arrangement and can be enlarged by adding further modules (micro-displays and directing optical systems).

A disadvantage of such a display device is the great complexity and high costs for arranging the micro-displays or modules and the corresponding computing capacity for programming and controlling the modules. Those display devices are thus rather suited as stand-alone devices for special purposes than for the average consumer.

It is thus the object of the present invention to provide a device on the basis of a multi-beam display and a method for presenting three-dimensional images in a reconstruction space such to circumvent the disadvantages of the prior art and to minimise the number of components required. In addition, the computational load needed for the realisation of three-dimensional images shall be reduced such that the device is also suitable to be used by an average consumer.

The object is solved according to this invention as regards the device aspect by the features of claim 1 and as regards the method aspect by the features of claim 13.

The object is solved according to this invention by a device for the presentation of three-dimensional images in a reconstruction space by spatial points which are intersecting points of at least two intersecting pencils of rays, said device comprising an image display device with pixels for the presentation of image information and a beam directing device. The image display device can for example be a conventional LC display with a certain screen diagonal, e.g. a 20″ display panel. The beam directing device transmits the pencils of rays which are emitted by the pixels of the image display device into pre-defined or specifiable directions, for example towards at least one observer, so that at least one spatial point can be generated in the reconstruction space. The pencils of rays which are emitted by the at least one spatial point are exclusively directed at least one virtual observer window which is generated in an observer plane, said observer window having a size which is not larger than the diameter of the eye pupil of an observer eye.

In the device according to this invention, the pencils of rays which reconstruct a spatial point or multiple spatial points are exclusively directed at least one virtual observer window which has a size which is not larger than the eye pupil of an observer eye. To be able to watch the spatial point(s) in the reconstruction space, it is therefore necessary for the eye pupil of the observer eye to be situated at the position of the virtual observer window. The observer eye is then focused on the presented spatial points and perceives them in the correct depth if at least two pencils of rays from each spatial point fall on the pupil of that eye.

The advantage of this device according to this invention lies in the concentration of the entire information which is emitted by the pixels in virtual observer windows. The amount of information which is to be processed can thus be minimised greatly, e.g. in contrast to the display devices disclosed in U.S. Pat. No. 6,798,390 B1 and US 2003/0156077 A1, because at a certain point of time only those perspective views of the three-dimensional image must be computed and reconstructed which are intended for the observer windows in which eyes of the at least one observer are actually situated. Moreover, a presentation of moving scenes (sequence of reconstructed three-dimensional images or objects) in real-time is thus only made possible at all or at least simplified. Because the device for the reconstruction of spatial points or image points or object points according to this invention only comprises or requires a small number of components and most of all because it does not require coherent light, a particular advantage over holographic display devices is that interference effects cannot occur or do not play a role, so that the quality of the presentation is not disturbed by speckling (coherent noise). In other words, the two intersecting pencils of rays with which at least one spatial point is generated in a reconstruction space are mutually incoherent.

Thanks to the substantial reduction in the device-related effort and computational load, it is possible that the inventive device is also used in the field of consumer video equipment, and that the device which is based on such a multi-beam display is suitable to be applied by an average consumer.

The beam directing device is generally provided for variably deflecting single or multiple pencils of rays, preferably continuously, for example by continuously variable angles. According to one embodiment of the invention, the beam directing device can comprise beam deflecting means, where each pixel or each group of adjacent pixels of the image display device is assigned with a beam deflecting means of the beam directing device. It can be particularly advantageous if the beam deflecting means are designed in the form of controllable prism elements. The controllable prism elements can for example be made and operated on the basis of the electrowetting effect (electrically controllable capillaries—variable focal length or variable deflection angle achieved by liquid micro-elements, e.g. water-oil mixtures).

In another preferred embodiment of the invention, a group of adjacently arranged beam deflecting means or prism elements of the beam directing device can form a Fresnel lens, where the beam deflecting means of the Fresnel lens follow the pixels or groups of pixels of the image display device in the direction of light propagation. The Fresnel lens can also be formed directly by a group of beam deflecting means or prism elements of the controllable beam directing device, where this group of beam deflecting means or prism elements is assigned to a group of pixels of the image display device of about the same size. The Fresnel lenses reconstruct in their focal points one spatial point each. The incoherent character of the reconstruction also persists in this embodiment of the device according to this invention.

It can be particularly advantageous if the deflection angles of the beam deflecting means or prism elements can be controlled in two perpendicular directions. It is thus possible to control and to emit the pencils of rays both in the horizontal and vertical direction according to the spatial point which is to be reconstructed.

In particular, an optical system can preferably be disposed between the image display device and the beam directing device to collimate the pencils of rays which are emitted by the pixels of the image display device, so that collimated pencils of rays fall on the beam deflecting means of the beam directing device.

The optical system can preferably be a lens array, in particular an array of micro-lenses, where each pixel or each group of adjacent pixels of the image display device is assigned with a lens of the lens array.

In order to prevent the mutual interference of light which is emitted by adjacent pixels as diffused light, a shutter arrangement, for example realised in the form of aperture masks, can preferably be disposed between the image display device and the optical system.

Because only the perspective view for the respective virtual observer window and thus only for the respective eye of an observer shall be computed and displayed, a position detection system for detecting the eye positions of at least one observer in the observer plane can preferably be provided.

The object of the invention is further solved by a method for the presentation of three-dimensional images in a reconstruction space, where pixels of an image display device emit towards a beam directing device pencils of rays which are deflected by the beam directing device in different directions such that at least one spatial point is generated in a reconstruction space by at least two intersecting—preferably mutually incoherent—pencils of rays, where the pencils of rays which are emitted by the at least one spatial point run through at least one virtual observer window in an observer plane and fall on the eye pupil of at least one eye of at least one observer, so that the at least one observer perceives a three-dimensional image through the at least one virtual observer window.

According to the present invention, the pencils of rays which are emitted by the spatial point to be presented are exclusively directed at least one virtual observer window which is generated in an observer plane. In order to be able to watch the spatial point or image point in the reconstruction space, the eye pupil of an observer eye must be at the same spatial position as the virtual observer window, so that at least two pencils of rays which are emitted by the spatial point fall on the eye pupil. To achieve a binocular depth perception, it is necessary that each spatial point emits at least four pencils of rays, of which at least two pencils of rays fall on the right observer eye and at least two other pencils of rays fall on the left observer eye. If the three-dimensional image or object shall be viewed by multiple observers, this can be realised by generating multiple observer windows (multi-user feature). The observer windows can also be arranged such that they are attached side by side (multi-view feature).

With the help of this method according to this invention, a substantial reduction in display capacity and computational load is achieved, because only the areas of the eye pupils of the observer(s) must be provided with information. The display capacity and computational load can be reduced further in that for example due to the typical arrangement of the eyes, which lie side by side horizontally, only the horizontal perspective is displayed and the presentation of the vertical perspective is omitted. In contrast to the wave-optical reconstruction of spatial points according to holographic methods, the inventive method is a ray-optical reconstruction method.

It can be particularly advantageous that the position of at least one eye of at least one observer in the observer plane is detected by a position detection system and that the at least one virtual observer window is tracked accordingly if the at least one observer moves in lateral and/or axial direction. This way, an observer of the three-dimensional image can continue watching the latter after a movement to another position, where the observer is presented either with the same perspective view of the three-dimensional image as before or with a different perspective view of the three-dimensional image, depending on what demands the observer makes on the device and method.

The positions of the pixels of the image display device which are to be activated for the reconstruction of the spatial points are determined by projecting the object to be presented on the image display device. The positions of the pixels of the image display device which are to be activated for the individual spatial points or image points are therefore preferably determined with the help of ray tracing from the observer eyes through the spatial points to the image display device.

Further embodiments of the invention are defined by the other dependent claims. Embodiments of the present invention will be explained in detail below and their working principle illustrated with the help of the accompanying drawings, where:

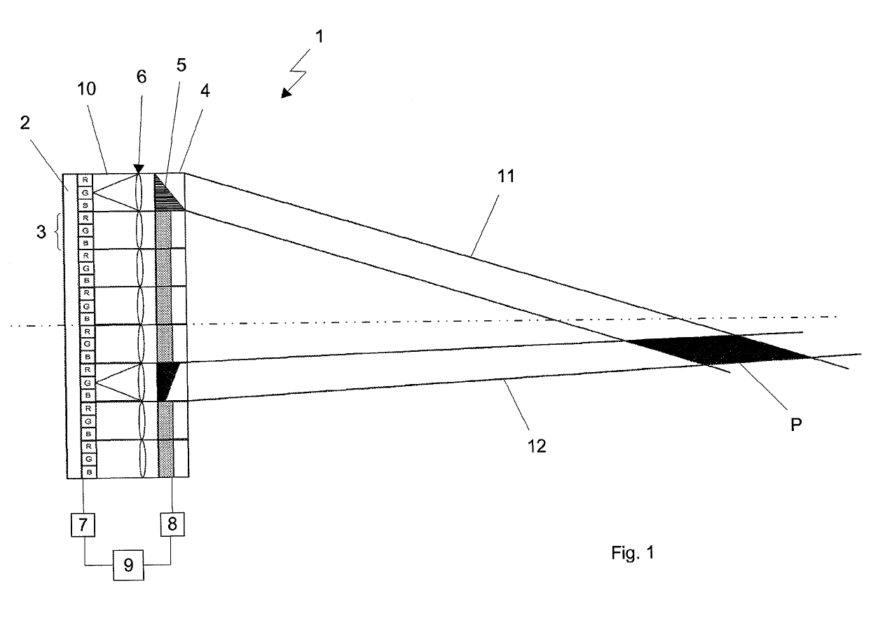

FIG. 1 is a schematic top view of a device for the presentation of three-dimensional images through spatial points according to this invention;

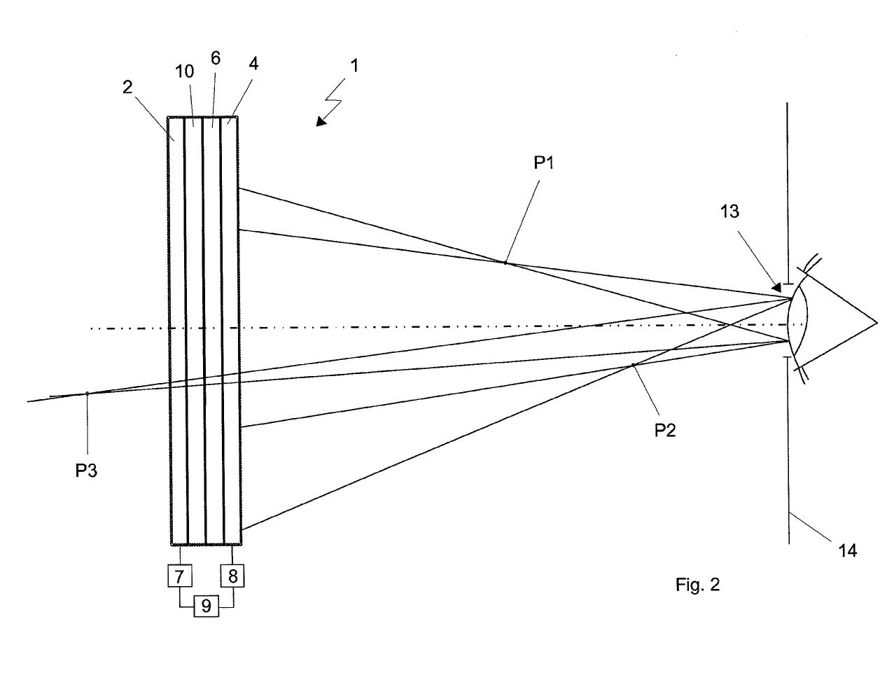

FIG. 2 is a schematic side view of the device shown in FIG. 1 together with a virtual observer window;

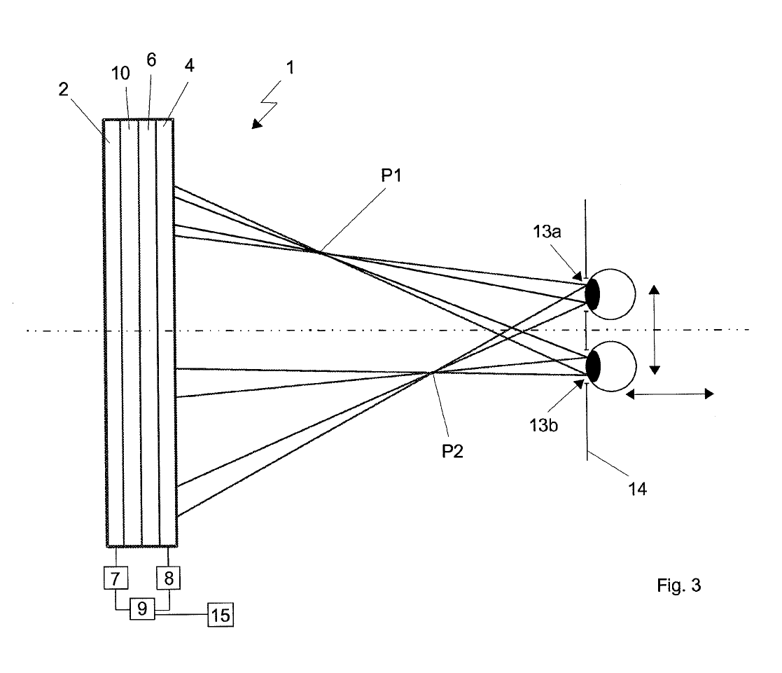

FIG. 3 is a schematic top view of the device shown in FIG. 1 together with two virtual observer windows; and

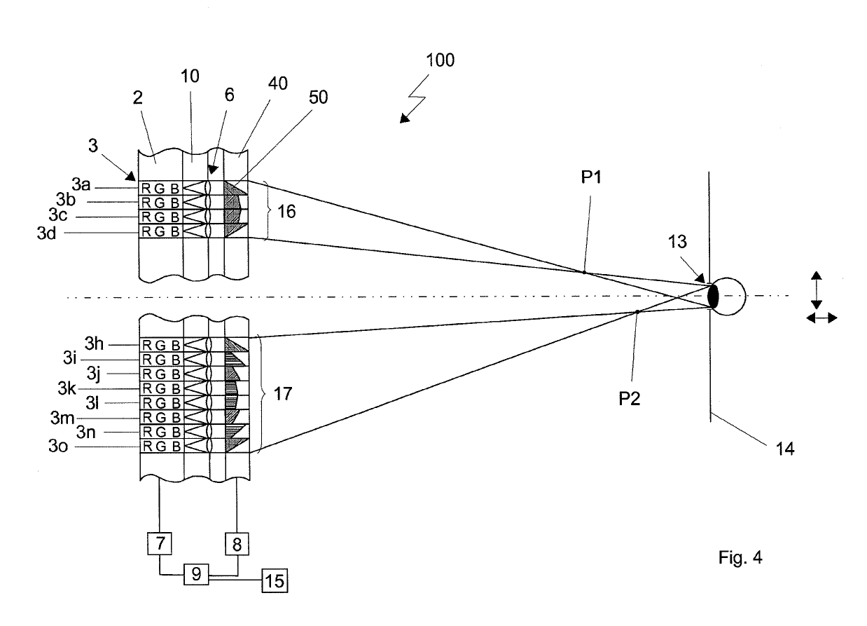

FIG. 4 is a schematic top view of a second embodiment of the inventive device together with a virtual observer window.

The embodiments described below relate mainly to direct-view displays or display devices which are viewed directly to watch a three-dimensional image. However, a realisation in the form of a projection device is possible as well, for example when using micro-displays.

Now, the design and function of a device 1 for the presentation of three-dimensional images in a reconstruction space will be described. While FIGS. 1 and 4 only show the outline rays of the pencils of rays, FIGS. 2 and 3 only show the principal rays of the pencils of rays.

FIG. 1 is a top view which illustrates the general design of the device 1, where the device 1 is greatly simplified. To allow three-dimensional presentations, the device 1 comprises an image display device 2 with a multitude of pixels 3 for presenting image information. Referring to FIG. 1, according to this invention a pixel 3 comprises three sub-pixels of the three primary colours red, green and blue (RGB), so that a three-dimensional image can be presented in colour, although a colour presentation of the three-dimensional image is not obligatory. The image display device 2 can be a conventional LC display with a desired screen diagonal, e.g. a 20″ display panel. Of course, other types and sizes of displays can be used as well as image display device 2.

The image display device 2 comprises an illumination device (not shown) in the form of a conventional backlight, while it is also possible that a light source is disposed behind each pixel. The backlight illuminates the pixels 3 incoherently. Of course, differently designed illumination devices can be provided in the image display device as well. It is for example possible to use an image display device which is based on self-luminous pixels.

A beam directing device 4 is disposed downstream the image display device 2 in the direction of light propagation and serves for directional control or deflection of the pencils of rays which are modulated with the desired information by the pixels. For this, the beam directing device 4, which is preferably of a two-dimensional design, comprises beam deflecting means 5, which have the form of direction-controlling elements. The beam deflecting means 5 can be controllable prism elements or lens elements which are arranged side by side so to provide an arrangement of multiple beam deflecting elements 5. The beam deflecting means 5 which serve to achieve a directional control of the incident pencils of rays are preferably designed according to the electrowetting principle and operate according to the electrowetting effect. The deflection angle of the individual beam deflecting means 5 can be controlled in two perpendicular directions so to allow a vertical and horizontal directional control of the individual pencils of rays. This way, a true or realistic three-dimensional image can be generated and presented in the reconstruction space which has a three-dimensional effect both in the horizontal and in the vertical direction. Such a device would require a large amount of information to be processed so that such a device is not very cost-effective in economic terms. Since the two eyes of an observer lie side by side horizontally, however, presenting the perspective of the three-dimensional image in the horizontal direction only is sufficient.

The image display device 2 and the beam directing device 4 are controlled in synchronism by controller means 7 and 8 so to present a spatial point or a three-dimensional image. In order to enable the image display device 2 and the beam directing device 4 to be controlled in synchronism, a control unit 9 is provided which transmits adequate control signals to the two controller means 7 and 8.

Moreover, an optical system 6 in the form of a lens array, preferably an array of micro-lenses, is disposed between the image display device 2 and the beam directing device 4. Each pixel 3 of the image display device 2 is assigned with a lens of the lens array 6. The image display device 2 is disposed in the object-side focal plane of the lens array 6. The pencils of rays which are emitted by the individual pixels 3 are thus collimated by the individual lenses of the lens array 6 such that parallel pencils of rays fall on the corresponding beam deflecting means 5 of the beam directing device 4, whereby the entire beam deflecting means 5 is illuminated homogeneously across its entire surface. Alternatively, the pixels 3 can preferably not be disposed in the object-side focal points of the lenses of the lens array 6, but slightly offset, so that the individual pixels 3 of the image display device 2 emit slightly diverging pencils of rays. This causes a slight overlapping of at least two pencils of rays in the eye or at the position where the observer is situated, whereby the continuous impression of the presentation of adjacent spatial points in the reconstruction space is even strengthened.

A shutter arrangement 10 is disposed between the image display device 2 and the optical system 6 in order to prevent or to minimise mutual interference of the pencils of rays by diffused light in the horizontal and/or vertical direction in the optical system 6 or in the individual lenses, in particular where the pixels 3 emit slightly diverging pencils of rays. This ensures a precise alignment of the pencil of rays which is emitted by a pixel 3 on the assigned beam deflecting means 5 of the beam directing device 4. A diffusion of the spatial point which is reconstructed or generated by the pencils of rays is thus widely prevented. The shutter arrangement 10 can be realised in the form of individual aperture masks based on a film of certain thickness.

At least two pencils of rays 11 and 12 are necessary to generate a spatial point P, as shown in FIG. 1. The positions of the pixels 3 of the image display device 2 which are to be activated for the individual spatial point P are determined with the help of ray tracing from the observer eye(s) through the spatial point P which is to be generated at the correct position to the image display device 2. Referring to FIG. 1, two pixels 3 are activated to reconstruct the spatial point P, and the two pencils of rays which are modulated with the desired information for the spatial point P by the two pixels 3 are collimated by the corresponding lenses of the optical system 6 and fall on the respectively provided beam deflecting means 5 of the beam directing device 4. The two beam deflecting means 5 are controlled by the controller means 8 such that the two collimated, mutually incoherent pencils of rays 11 and 12 are deflected in certain predefined directions and intersect at the desired position in the reconstruction space. The variable deflection of the pencils of rays 11 and 12 by the beam deflecting means 5 is achieved by the above-mentioned electrowetting effect. The pencils of rays 11 or 12 thus reconstruct the spatial point P in their intersecting point.

FIG. 2 illustrates the reconstruction of multiple spatial points, here three spatial points P1, P2 and P3 in the reconstruction space. The image display device 2, the shutter arrangement 10, the optical system 6 and the beam directing device 4 are the same components as shown in FIG. 1, and identical components are therefore given the same reference numerals. Moreover, the components 2, 10, 6 and 4 of the device 1 are greatly simplified in the drawing. As already described above in context of FIG. 1, at least two intersecting pencils of rays are required to generate a spatial point. Each of the three spatial points P1, P2 or P3 shown in the drawing is thus generated or reconstructed by at least two intersecting pencils of rays, where only the principal rays of the respective pencils of rays are shown here in the drawing. As can be seen, different pixels 3 of the image display device 2 must be activated to generate multiple spatial points. In addition, a spatial point can also be situated before the image display device 2, seen in the direction of light propagation, which serves to illustrate that the reconstruction space can also extend beyond the image display device 2, seen against the direction of light propagation. By reconstructing multiple spatial points, a three-dimensional image can be generated which can be watched by at least one observer.

A characterising feature of the device 1 is that the pencils of rays which are emitted by the spatial points P1, P2 and P3 are exclusively directed at a virtual observer window 13 which lies in an observer plane 14 which is situated in the direction of light propagation at a distance to the beam directing device 4 which corresponds with the distance of the observer. The observer eye perceives the presented spatial points P1, P2 and P3 through this virtual observer window 13, whose size is not larger than the diameter of the eye pupil of the observer eye, i.e. which is about as large as the eye pupil of the observer eye, and which roughly coincides spatially with this eye pupil, in the correct depth if at least two pencils of rays fall on the eye pupil from each spatial point P1, P2 and P3, as shown in the drawing. In other words, if the observer wants to watch the spatial points P1, P2 and P3, or the image which is represented by these points, he must bring his eye pupil to the position of the virtual observer window 13, so that the pencils of rays which are emitted by the spatial points P1, P2 and P3 run through the virtual observer window 13 in the observer plane 14 and fall on the eye pupil, thereby causing the eye to focus on the spatial points P1, P2 and P3. Because the perspective view is only computed and displayed for the observer window 13, the amount of information to be processed is reduced substantially, so that such a device 1 according to this invention can also be realised for an average consumer, e.g. in the field of media applications.

Referring to FIG. 3, two virtual observer windows 13a and 13b are provided in the observer plane 14, namely the virtual observer window 13a for the right eye, and the virtual observer window 13b for the left eye of the observer, to enable an observer to watch the generated spatial points or the reconstructed image with both eyes. As in FIG. 2, the image display device 2, the shutter arrangement 10, the optical system 6 and the beam directing device 4, which can be considered to be one unit, are shown in a very simplified manner, where the components which have already been shown in FIG. 1 are given the same reference numerals. FIG. 3 illustrates the presentation of two spatial points P1 and P2 at different depths for both eyes of an observer. For a binocular depth perception, and thus for the perception of a three-dimensional image which is represented by the spatial points P1 and P2 and further spatial points, each spatial point P1 and P2 is required to emit at least four pencils of rays (again only represented by their principal rays in the drawing). Of those, at least two pencils of rays must be directed at and fall on the virtual observer window 13a, and at least two pencils of rays must be directed at and fall on the virtual observer window 13b, so that the pencils of rays fall on the respective eye pupils and the observer sees the three-dimensional image if the eye pupils are situated at the positions of the virtual observer windows 13a and 13b, respectively. In order to generate at least four pencils of rays, at least four pixels 3 of the image display device 2 must be activated.

To enable the observer to continue watching the three-dimensional image or the spatial points P1 and P2 with the correct depth impression after a movement to another position, the virtual observer windows 13a and 13b must be tracked accordingly, as is indicated by the double arrows in the drawing. In order to detect the new position of the observer eye(s), a position detection system 15 is provided in the device 1. The virtual observer windows 13a and 13b can be tracked in the lateral and/or axial direction in that the image display device 2 and the beam directing device 4 are controlled by the control unit 9 according to the new eye position which has been detected by the position detection system 15. Of course, the same goes for the virtual observer window 13 in FIG. 2.

After tracking of the two observer windows 13a and 13b, the observer is presented for example the same view of the spatial points P1 and P2, where the image display device 2 is programmed or encoded such that the spatial points or the three-dimensional image are turned accordingly. It is of course also possible that the image display device 2 is re-encoded such that the observer can watch a different perspective view of the spatial points P1 and P2 or of the three-dimensional image after a position change and thus after tracking of the observer windows 13a and 13b, where the spatial points or the three-dimensional image are fixed (panorama view). This means that the individual observer or multiple observers can either always be presented with the same perspective view or with different views of the three-dimensional image when they move in lateral and/or axial direction in front of the device 1. However, if different views of the three-dimensional image are presented, complexity and costs will increase, in particular the effort as regards the re-encoding of the image display device 2. In order to keep the computational load low, the presentation of the vertical perspective of the three-dimensional image can be omitted, as has already been described above in the context of FIG. 1. The spatial points P1 and P2 can either be presented simultaneously or sequentially at a fast pace, depending on whether space-division or time-division multiplexing methods are used.

Because for a binocular presentation of a spatial point, e.g. the spatial point P1, at least four pixels 3 of the image display device 2 must be activated, the spatial resolution of the device 1 is maximal one fourth of the resolution of the image display device 2, if space-division multiplexing is employed for the pixels 3 which are to be activated in order to generate the two virtual observer windows 13a and 13b, i.e. for both observer eyes. However, there is also the possibility not to serve the two virtual observer windows 13a and 13b, i.e. both eyes of the observer, by space-division multiplexing, but by time-division multiplexing. In that case, the spatial resolution of the device 1 is only reduced to one half, or it remains the same as that of the image display device 2 if the display frequency is increased twofold or fourfold compared with the original frequency of the image display device 2.

Of course, the device 1 can also be designed such that multiple observers can watch the spatial points P1 and P2 or the three-dimensional image from observer windows which are accordingly dedicated to them. If this is the case, a mixed time- and space-division multiplexing can preferably be employed. For example, both eyes of an observer can be addressed by space-division multiplexing, while the individual observers are addressed by time-division multiplexing. It is also possible to serve two observers by space-division multiplexing, where the image information is interleaved e.g. column-wise on the image display device 2. However, this is not very preferable if more than two observers are to be served, because the spatial resolution of the image display device 2 per observer is then very low. Further, it is also possible to serve multiple observers merely by time-division multiplexing. Of course, multiple observers can also be served by other multiplexing methods which have not been mentioned here.

In addition to the procedure which is illustrated in FIGS. 1 to 3, FIG. 4 illustrates a further possibility for the reconstruction of spatial points with the example of the device 100. The image display device 2, the shutter arrangement 10 and the optical system 6 are shown in a section of the device 100 only, and they can be of same design as described above in the context of FIGS. 1 to 3, which is why they are given the same reference numerals. However, different designs are possible as well. The sub-pixels RGB of a pixel 3 are here shown one behind another, but this only serves to simplify the representation of a pixel 3 in the drawing. The sub-pixels of a pixel 3 are in reality generally disposed side by side in the image display device 2, as shown in FIG. 1. Referring to FIG. 4, the spatial points P1 and P2 are reconstructed on the basis of the encoding of the spatial points as focal points of Fresnel lenses, which is used in holographic reconstruction methods with the help of computer-generated holograms (CGH). A group of multiple beam deflecting means 50 which are arranged side by side, here four beam deflecting means, of a beam directing device 40 form a Fresnel lens 16. The group of beam deflecting means 50 is here assigned to a group of pixels 3, here the corresponding four pixels 3a to 3d, of the image display device 2, where again each individual pixel 3 is assigned with a certain beam deflecting means 50. The beam deflecting means 50 can again be prism elements or lens elements which are designed and operated according to the electrowetting effect, where the beam deflecting means 50 direct multiple pencils of rays which fall on them in different directions, so that the pencils of rays intersect in one point, thereby generating a spatial point P1 in the reconstruction space. This means that for the reconstruction of the spatial point P1 the pixels 3a to 3d are activated by the controller means 7 of the control unit 9, where the pencils of rays which are emitted by the pixels 3a to 3d are collimated by the optical system 6 and fall on the Fresnel lens 16. The four beam deflecting means 50 of the Fresnel lens 16 have different beam deflection properties or a different deflection behaviour (deflection angles), depending on the spatial point P1, which are controlled by the controller means 8. Now, the Fresnel lens 16 which is thus formed to reconstruct the point P1 focuses the light which is modulated by the pixels 3a to 3d and characterised by four pencils of rays on a point in the reconstruction space, thereby reconstructing the spatial point P1. The four pencils of rays which are emitted by that spatial point P1 must run through the observer window 13 and fall on the eye pupil of the observer eye which is situated at the same position as the observer window 13, so that the observer can watch the spatial point P1. As already described above in the context of FIG. 3, the observer window 13 can be tracked in lateral and/or axial direction if the observer moves, as indicated by double arrows in the drawing. To be able to do so, the position detection system 15 detects the eye position of the observer eye at the new position.

To reconstruct the spatial point P2, a Fresnel lens 17 is formed by the beam deflecting means 50. What has been said above with respect to the reconstruction of the spatial point P1 and to the formation of the Fresnel lens 16 can be applied analogously to the spatial point P2, while the Fresnel lens 17, however, is formed by eight beam deflecting means 50. The pixels 3h to 3o of the image display device 2 are activated to illuminate the beam deflecting means 50. The spatial point P2 is thus reconstructed by eight intersecting pencils of rays. This means that the Fresnel lenses 16 and 17 of the beam directing device 40 differ in size depending on the reconstruction location of the spatial points P1 and P2. Because the individual rays of light of the pencils of rays are mutually incoherent, the incoherent character of the reconstruction persists also if the spatial points are reconstructed with the help of Fresnel lenses. In contrast to holographic reconstruction methods, where coherent light is used for the reconstruction, the pencils of rays can here not interfere, as is also the case in FIGS. 1 to 3, so that the reconstruction is not disturbed by coherent noise (speckling).

In order to minimise the required display capacity and computational load further, it is also possible when using Fresnel lenses 16 and 17 for generating the spatial points P1 and P2 to encode or program these lenses only in one dimension, i.e. horizontally or vertically. This means that if the Fresnel lens 16 or 17 is only programmed horizontally in the beam directing device 40 then it only takes up a part of a row. However, if the Fresnel lens 16 or 17 is only programmed vertically then it only takes up a part of a column, depending on which type of one-dimensional programming is actually used. As already mentioned above, the size of the Fresnel lenses 16 and 17 depends on the distance of the spatial point to be reconstructed from the beam directing device 40. Because the number of pixels 3 of the image display device 2 which must be activated to contribute to the reconstruction of the spatial points P1 and P2 also varies due to the different sizes of the Fresnel lenses 16 and 17, the spatial points P1 and P2 are reconstructed at a different depth in the reconstruction space and with a different brightness. However, in order to give the spatial points P1 and P2 the same brightness, the brightness of the spatial points can be controlled and adapted individually, e.g. by controlling the brightness of the pixels 3 which contribute to a certain spatial point, or by encoding the luminance of the respective pixels 3.

Of course, it is also possible with this device 100 that multiple observers can watch the spatial points P1 and P2, or the three-dimensional image, through dedicated observer windows, where again always the same perspective view or different views of the spatial points P1 and P2, or of the three-dimensional image, can be presented, as has been described in the context of FIG. 3.

The embodiments which have been described above and illustrated with the help of FIGS. 1 to 4 relate to a direct-view display as device 1 or 100. However, a realisation of project-specific solutions, for example using micro-displays, is possible as well if controllable prism elements are available in an accordingly fine grid as beam deflecting means 5 or 50, where no demands must be made on respective high-intensity illumination devices with respect to coherence.

It goes without saying that further embodiments of the device 1, 100 are possible, where the FIGS. 1 to 4 only illustrate preferred embodiments, and where combinations of individual embodiments are thinkable as well. Modifications of the embodiments shown above are thus possible without leaving the scope of the invention. All possible embodiments have in common that they require a substantially lower display and processing capacity compared with the prior art.

Possible fields of application of the device 1, 100 for the presentation of three-dimensional images include in particular the consumer electronics sector and working appliances, such as TV displays, electronic games, the automotive industry for the display of informative or entertaining contents, and medical technologies. It appears to those skilled in the art that the inventive device 1, 100 can also be applied in other areas not mentioned above.

1. Device for the presentation of in particular three-dimensional images in a reconstruction space by spatial points which are intersecting points of at least two intersecting—preferably mutually incoherent—pencils of rays, with an image display device with pixels for the presentation of image information and with a beam directing device which transmits the pencils of rays which are emitted by the image display device into specifiable directions, such that at least one spatial point can be generated in the reconstruction space, where the pencils of rays which are emitted by the at least one spatial point are directed at least one virtual observer window in an observer plane, where the size of said observer window is not larger than the eye pupil of an observer eye.

2. Device according to claim 1, wherein the beam directing device comprises beam deflecting means, where each pixel or group of adjacently arranged pixels of the image display device is assigned with a beam deflecting means of the beam directing device.

3. Device according to claim 2, wherein the deflection behaviour of the beam deflecting means can be controlled.

4. Device according to claim 2, the beam deflecting means (5, 50) are prism elements, in particular elements which are based on the electrowetting effect.

5. Device according to claim 2, wherein a group of adjacently arranged beam deflecting means or prism elements of the beam directing device form a Fresnel lens, where each beam deflecting means of the Fresnel lens is assigned to a pixel or group of pixels of the image display device and disposed downstream the latter in the direction of light propagation.

6. Device according to claim 2, wherein the deflection angles of the beam deflecting means can be controlled in two perpendicular directions.

7. Device according to claim 1, wherein an optical system provided for affecting the pencils of rays which are emitted by the image display device is disposed between the image display device and the beam directing device.

8. Device according to claim 7, wherein the optical system is a lens array, in particular an array of micro-lenses, where each pixel or group of adjacently arranged pixels of the image display device is assigned with one lens of the lens array.

9. Device according to claim 7, wherein the image display device is disposed in the object-side focal plane of the optical system.

10. Device according to claim 7, characterised in that a shutter arrangement is disposed between the image display device and the optical system.

11. Device according to claim 1, wherein a position detection system is provided for detecting eye positions of at least one observer in the observer plane.

12. Device according to claim 1, wherein a control unit is provided for controlling the image display device and beam directing device according to the actual eye position of at least one observer as detected by the position detection system.

13. Method for the presentation of in particular three-dimensional images in a reconstruction space, where pixels of an image display device emit towards a beam directing device pencils of rays which are transmitted by the beam directing device in different directions such that at least one spatial point is generated in a reconstruction space by at least two intersecting—preferably mutually incoherent—pencils of rays, where the pencils of rays which are emitted by the at least one spatial point run through at least one virtual observer window in an observer plane and fall on the eye pupil of at least one eye of at least one observer, so that the at least one observer perceives a three-dimensional image through the at least one virtual observer window.

14. Method according to claim 13, wherein at least two pixels of the image display device are activated for generating a spatial point.

15. Method according to claim 13, wherein beam deflecting means of the beam directing device are controlled such that the pencils of rays which are emitted by the activated pixels and which fall on the image display device are transmitted in pre-defined directions by the latter.

16. Method according to claim 15, wherein a group of multiple adjacently arranged beam deflecting means of the beam directing device form a Fresnel lens, which transmits incident pencils of rays in different directions such that a spatial point is generated at their intersecting point in the reconstruction space.

17. Method according to claim 13, wherein the pencils of rays which are emitted by the pixels are at least roughly collimated by an optical system before they fall on the beam directing device.

18. Method according to claim 13, wherein the position of at least one eye of at least one observer in the observer plane is detected by a position detection system and that the at least one virtual observer window is tracked accordingly if the at least one observer moves in lateral and/or axial direction.

19. Method according to claim 13, wherein for a spatial point or a three-dimensional image to be watched with both eyes at least two pencils of rays from at least one spatial point run through a virtual observer window and fall on the one eye, and that at least two pencils of rays run through another virtual observer window and fall on the other eye of the at least one observer.

20. Method according to claim 13, wherein the pixels which are to be activated in the image display device for the positions of individual spatial points in the reconstruction space are determined by ray tracing starting at the eyes of at least one observer.

21. Method according to claim 16, wherein the brightness of individual spatial points which are reconstructed by Fresnel lenses is controlled by way of encoding the luminance of the contributing pixels of the image display device.
